(19) United States
(12) Patent Application Publication
(10) Pub. No.: US 2011/0041987 A1
(43) Pub. Date: Feb. 24, 2011

(54) METHOD FOR MANUFACTURING COMPOSITE SUBSTRATE

(75) Inventors: Yuji HORI, Nagoya-City (JP); Hiroki Kobayashi, Chiryu-City (JP); Yasunori Iwasaki, Kitanagoya-City (JP)

Correspondence Address: BURR & BROWN, PO BOX 7068, SYRACUSE, NY, 13261-7068, US

(73) Assignee: NGK Insulators, Ltd., Nagoya-City (JP)

(21) Appl. No.: 12/861,895

(22) Filed: Aug. 24, 2010

(30) Foreign Application Priority Data
Aug. 24, 2009 (JP) 2009-193521

(51) Int. Cl. B32B 38/10

(52) U.S. Cl. 156/153

(57) ABSTRACT

A method for manufacturing a composite substrate according to the present invention includes a formation step of forming a structural element portion on a front surface of a first substrate, a grinding step of fixing the first substrate and grinding a back surface of the first substrate, and a bonding step of bonding a second substrate to the ground back surface with an adhesion layer composed of an adhesive. In such a manner, before forming the adhesion layer, the handling properties of which are affected by heating, and before grinding the first substrate, the strength of which is decreased by grinding, a process of forming the structural element portion, including a heating step, is performed. Furthermore, a piezoelectric substrate may be used as the first substrate, and a supporting substrate which supports the piezoelectric substrate may be used as the second substrate.

### BACKGROUND OF THE INVENTION

1. Field of the Invention

The present invention relates to a method for manufacturing a composite substrate and to a composite substrate.

2. Description of the Related Art

It is already known that in order to improve its characteristic, composite substrate, in which a supporting substrate and a piezoelectric substrate are bonded together, is provided with electrodes to fabricate an elastic wave element. For example, elastic wave elements have been used as band-pass filters in communication devices, such as mobile phones. Composite substrates are known to use lithium niobate or lithium tantalate as a piezoelectric substrate and silicon or quartz or ceramics as a supporting substrate (see Japanese Unexamined Patent Application Publication No. 2006-319679).

### SUMMARY OF THE INVENTION

Generally, in such composite substrates, after substrates are bonded together, elastic wave devices are fabricated. For example, in a composite substrate in which substrates having different coefficients of thermal expansions are bonded together, the substrates may be warped because of the temperature (heating) in the device fabrication process. Therefore, it is necessary to take measures, such as use of fabrication equipment in response to the warpage caused, or adjustment of the temperature-decreasing time so as to prevent warpage. Furthermore, it is not possible to carry out a heating step that may damage the adhesion layer or the composite substrate itself. Consequently, there are various limitations in the manufacturing process.

The present invention has been achieved in view of the problems described above. It is a principal object of the present invention to provide a method for manufacturing a composite substrate including a first substrate and a second substrate bonded together by an adhesion layer, in which it is possible to reduce the limitations in the manufacturing process.

As a result of diligent studies conducted by the present inventors to achieve the principal object described above, it has been found that, by using a method in which, after a structural element portion is formed on a surface of a piezoelectric substrate in advance, the piezoelectric substrate is ground from the back side, and then a supporting substrate is bonded thereto, a composite substrate can be manufactured in a state where limitations in the manufacturing process are reduced, and thereby the present invention has been completed.

According to the present invention, a method for manufacturing a composite substrate includes:

a formation step of forming a structural element portion on a front surface of a first substrate;

a grinding step of fixing the first substrate and grinding a back surface of the first substrate; and

a bonding step of bonding a second substrate to the ground back surface with an adhesion layer composed of an adhesive.

In the method for manufacturing a composite substrate according to the present invention, the limitations in the manufacturing process can be reduced. The reason for this is that, for example, before forming an adhesion layer, the handling properties of which are affected by heating, and before grinding the first substrate, the strength of which is decreased by grinding, a process of forming the structural element portion, including a heating step, is performed.

### BRIEF DESCRIPTION OF DRAWINGS

FIG. 1 is a cross-sectional view schematically showing an example of a manufacturing process of a composite substrate 10; and

FIG. 2 is a schematic view showing a structure of a composite substrate 10 and an elastic wave device 30.

### BEST MODES FOR CARRYING OUT THE INVENTION

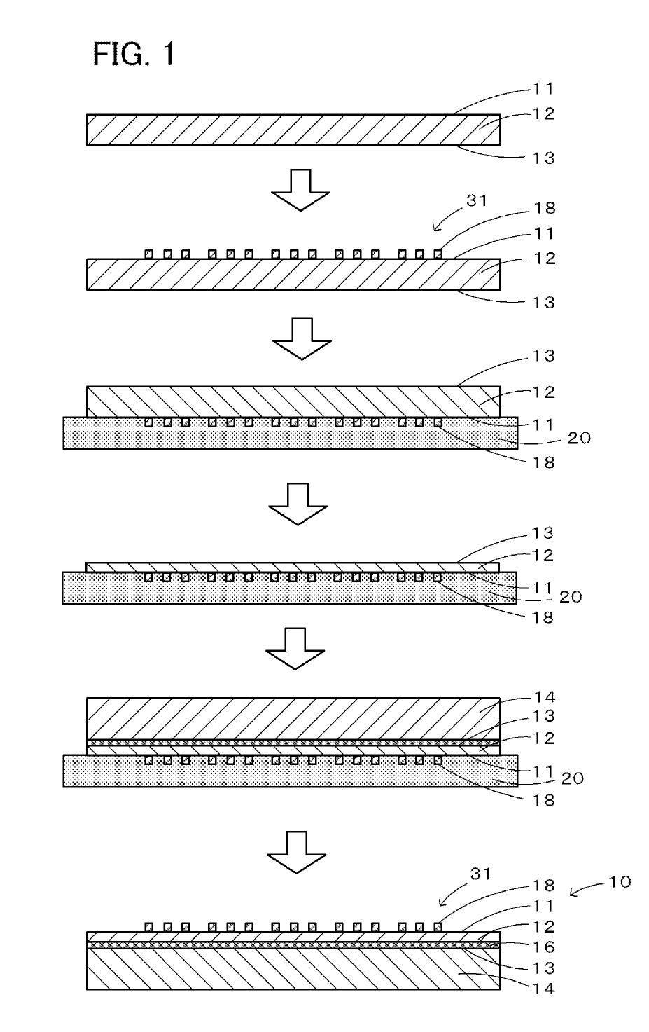

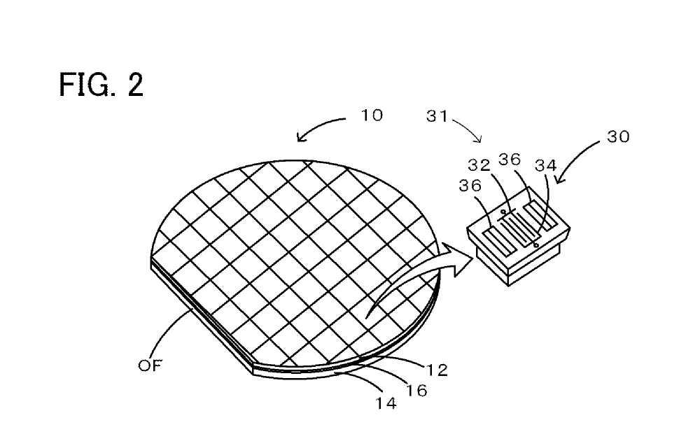

Embodiments of the present invention will be described below with reference to the drawings. FIG. 1 is a cross-sectional view schematically showing an example of a manufacturing process of a composite substrate 10, and FIG. 2 is a schematic view showing a structure of the composite substrate 10 and an elastic wave device 30. A method for manufacturing a composite substrate according to the present invention includes a formation step of forming a structural element portion on a front surface of a first substrate, a grinding step of fixing the first substrate and grinding a back surface of the first substrate, and a bonding step of bonding a second substrate to the ground back surface with an adhesion layer composed of an adhesive. As shown in the bottom stage of FIG. 1, the composite substrate 10 of the present invention includes a first substrate 12 provided with a structural element portion 31, a second substrate 14, and an adhesion layer 16 which bonds together the first substrate 12 and the second substrate 14. Examples of such a composite substrate include a composite substrate for an elastic wave device including a first substrate serving as a piezoelectric substrate and a second substrate serving as a supporting substrate which supports the piezoelectric substrate (refer to FIG. 2), and a composite substrate including a first substrate serving as a semiconductor substrate and a second substrate serving as a supporting substrate. Examples of the elastic wave device include surface acoustic wave devices, Lamb wave devices, and film bulk acoustic resonators (FBARs).

(Formation Step)

In the formation step, the structural element portion 31 is formed on a front surface 11 of the first substrate 12 (refer to first and second stages of FIG. 1). The structural element portion includes, for example, a structure that fulfills the device function of the composite substrate. As the first substrate 12, for example, a piezoelectric substrate, a semiconductor substrate, or the like may be used. When the first substrate 12 serves as a piezoelectric substrate, for example, at least one of lithium tantalate, lithium niobate, lithium niobate-lithium tantalate solid solution single crystal, lithium triborate (LBO), langasite, and quartz can be used. In this case, the structural element portion 31, for example, can include electrodes 18 and the like for an elastic wave device. Furthermore, the structural element portion 31 is formed, for example, by a commonly used photolithographic technique, in which a metal film is formed on the front surface 11 of the first substrate 12 by sputtering of an electrode material, followed by resist coating, patterning, and etching to form an electrode pattern. For example, as shown in FIG. 2, interdigital transducer (IDT) electrodes 32 and 34 (also referred to as “comb-shaped electrodes” or “interdigital electrodes”) and reflector electrodes 36 may be formed on a piezoelectric substrate so that many elastic wave devices are collectively arranged. Furthermore, when the first substrate 12 serves as a semiconductor substrate, for example, at least one of single crystal silicon, germanium, gallium arsenide, gallium arsenide phosphide, gallium nitride, and silicon carbide can be used. In this case, the structural element portion 31, for example, can include electrodes 18 and the like for a semiconductor device. In the process of forming the structural element portion 31, doping of impurity atoms, such as ion implantation or impurity diffusion, which is a high temperature process, may be performed.

(Grinding Step)

In the grinding step, the first substrate 12 is fixed, and a back surface 13 of the first substrate 12 is ground (refer to third and fourth stages in FIG. 1). The first substrate 12 can be fixed, for example, by turning over the first substrate 12 and attaching a dicing tape 20 to the front surface 11 of the first substrate 12. After the first substrate 12 is fixed as described above, the first substrate 12 is placed between a lapping plate and a pressure plate, and a slurry containing abrasive grains is supplied between the first substrate 12 and the lapping plate. With the first substrate 12 being pressed against the surface of the lapping plate by the pressure plate, the pressure plate is rotated, and thereby, the thickness of the first substrate 12 can be decreased. In the case where mirror polishing is performed, the lapping plate is replaced with a lapping plate having a pad on its surface and the abrasive grains are replaced with abrasive grains having a higher grit count, and the pressure plate is rotated and revolved to perform mirror polishing of the back surface 13 of the first substrate 12.

(Bonding Step)

In the bonding step, the second substrate 14 is bonded with an adhesion layer 16 composed of an adhesive to the ground back surface 13. The second substrate 14 may be, for example, a supporting substrate which supports the first substrate 12. In the case where a piezoelectric substrate is used as the first substrate 12, for example, a silicon substrate (Si(111) substrate, Si(100) substrate, or the like), a glass substrate, a sapphire substrate, an Al₂MgO₄ spinel substrate, or the like can be used as the supporting substrate. The supporting substrate may have a coefficient of thermal expansion different from that of the piezoelectric substrate. Preferably, the supporting substrate has a smaller coefficient of thermal expansion than the piezoelectric substrate. The difference in the coefficient of thermal expansion between the supporting substrate and the piezoelectric substrate may be 6 ppm/K or more. Even if the difference in the coefficient of thermal expansion is 6 ppm/K or more, because of the shape of the piezoelectric substrate, it is possible to prevent the occurrence of defects which may be caused by heating. When the coefficient of thermal expansion of the piezoelectric substrate is 13 to 20 ppm/K, preferably, a supporting substrate having a coefficient of thermal expansion of 2 to 7 ppm/K is used. Table 1 shows the coefficients of thermal expansion of typical materials used for the piezoelectric substrate and the supporting substrate when the first substrate serves as the piezoelectric substrate and the second substrate serves as the supporting substrate in the composite substrate 10. In the case where a semiconductor substrate is used as the first substrate 12, for example, SiC or carbon having high thermal conductivity can be used for the supporting substrate. The adhesion layer 16 is preferably composed of a heat-resistant organic adhesive, and for example, an epoxy adhesive, an acrylic adhesive, or the like can be used. The adhesive may be disposed, for example, by spin coating or the like on at least one of the back surface 13 of the first substrate 12 and a surface of the second substrate 14. After the first substrate 12 and the second substrate 14 are bonded together by the adhesion layer 16, the dicing tape 20 may be removed to obtain the composite substrate 10, or dicing may be directly performed. By performing dicing, a plurality of chips can be obtained, each chip having the structural element portion 31 provided on the front surface 11.

TABLE 1

| | | Coefficient |
|---|---|---|
| | | of Thermal |
| | | expansion |
| | Material | (ppm/K) |
| Piezoelectric | Lithium tantalate (LT) | 16.1 |
| substrate | Lithium niobate (LN) | 15.4 |
| | Quartz | 13.7 |
| | Lithium triborate | 13 |
| | (LBO) | |
| Supporting | Silicon | 3 |
| substrate | | |

In the method for manufacturing a composite substrate described above, it is possible to reduce the limitations in the manufacturing process. For example, in the case where, after a first substrate and a second substrate are bonded together by an adhesion layer, the surface of the first substrate is ground to reduce the thickness, and then a structural element portion is formed on the surface of the first substrate, there may be limitations in the manufacturing process, such as a need to perform treatment in response to heating during the formation of the structural element portion. In contrast, in the present invention, a process of forming the structural element portion is performed before forming the adhesion layer, the handling of which is affected by heating, and before grinding the first substrate, the strength of which is decreased by grinding. Therefore, the limitations in the manufacturing process after bonding of the second substrate 14 are substantially eliminated. Furthermore, by using the bonded structure in which the second substrate 14 is bonded by the adhesion layer 16, it is possible to provide a function that cannot be realized by a single substrate.

It is to be understood that the present invention is not limited to the embodiments described above, and various modifications are possible within the technical scope of the present invention.

### EXAMPLES

Examples in which composite substrates were fabricated will be described below as Examples.

### Example 1

A 40Y-X LiTaO₃ substrate (piezoelectric substrate) with a thickness of 0.35 mm was cleaned, and then an Al film with a thickness of 2,400 Å was formed thereon by sputtering. A positive resist was applied and baked, and then an electrode pattern was transferred. The wafer subjected to a development step was placed in a reactive ion etching (RIE) system, and Al electrodes were formed by etching using chlorine-based gas. In such a manner, comb-shaped electrodes with a width of 4 μl were periodically formed, and 1-port surface acoustic wave (SAW) resonator devices were fabricated over the entire surface of the wafer. In order to protect the devices, a resist was applied again to the wafer. The substrate was attached to a dicing tape such that the device side corresponded to the lower surface, and grinding was performed using a grinder apparatus until the thickness of the substrate became 40 μm. In order to remove swarf during the grinding, the ground surface side was cleaned by scrubbing. Next, an adhesive was thinly applied to a Si(111) supporting substrate with a thickness of 0.22 mm, and the thinned LiTaO₃ substrate was attached thereto. The adhesive was temporarily cured. At this point, the wafer was detached from the dicing tape, and organic cleaning was performed to remove the protective resist film. Then, the entire substrate was heated to 200° C. in a clean oven to cure the adhesive. The frequency characteristic of the SAW device thus fabricated was measured to be equal to that of a SAW device formed on a single substrate. Furthermore, the temperature characteristic of resonant frequency was checked. In a device in which a piezoelectric substrate was bonded to a supporting substrate, a surface of the piezoelectric substrate was ground, and an electrode was formed on the ground surface, the temperature characteristic of resonant frequency was −40 ppm/K. In the device on the bonded substrate to which the manufacture method of the present invention was applied, the temperature characteristic of resonant frequency improved to −25 ppm/K.

### Example 2

A 15 Y-cut LiNbO₃ substrate with a thickness of 0.25 mm was prepared as a piezoelectric substrate. A resist was spin-coated at a thickness of about 4,000 Å on the surface of the substrate cleaned with an organic solvent and pure water. The wafer was heated for two minutes on a hot plate at 80° C. to cure the resist. A photomask pattern was transferred onto the resist using an i-line aligner, and then development was performed. The wafer was placed in a vacuum evaporation system, and an aluminum film was formed at a thickness of 2,000 Å. The wafer was immersed in a resist stripper to remove the resist and unwanted aluminum film. Thereby, a SAW filter pattern was formed. In order to protect the SAW filter pattern from damage during the grinding step, a resist was spin-coated on the surface of the wafer provided with the SAW filter pattern, and thermal curing was performed in the same manner as above. Wax was applied to the resist surface of the wafer provided with the pattern, and the wafer and a separately prepared LiNbO₃ raw wafer (holding substrate) were bonded to each other. The thickness of the wax was about 20 μm. The bonded wafer was set on a grinder such that the back surface of the wafer provided with the pattern was directed upward, and grinding was performed until the thickness became 25 μm. Then, the surface was polished using a precision polishing machine until the thickness became 20 μm. An adhesive was thinly applied to a separately prepared glass substrate (supporting substrate), and the polished surface of the bonded wafer was bonded thereto under pressure. The combined wafer was placed in an oven and heated to 200° C. As a result, the wax was melted, and it was possible to remove the holding substrate. Since the adhesive is cured at high temperature, the glass substrate and the thinned LiNbO₃ wafer were strongly bonded together, and a composite substrate was thereby obtained.

### Examples 3 to 5

A composite substrate of Example 3 was obtained by the same procedure as in Example 2 except that a 64Y-X LiNbO₃ substrate was used as the piezoelectric substrate, and a Si(100) substrate was used as the supporting substrate. Furthermore, a composite substrate of Example 4 was obtained by the same procedure as in Example 2 except that a 46.3Y-X LiTaO₃ substrate was used as the piezoelectric substrate, and a sapphire substrate was used as the supporting substrate. Furthermore, a composite substrate of Example 5 was obtained by the same procedure as in Example 2 except that a 4Y-X LiNbO₃ substrate was used as the piezoelectric substrate, and an Al₂MgO₄ spinel substrate was used as the supporting substrate. Table 2 shows the combination of the piezoelectric substrate and the supporting substrate used for the fabrication. As described above, it has been confirmed that, using various piezoelectric substrates and supporting substrates of Examples 1 to 5, composite substrates can be fabricated by the manufacturing method of the present invention.

TABLE 2

| | Piezoelectric | Supporting |
|---|---|---|
| | substrate | substrate |
| Example 1 | 40Y—X LiTaO₃ | Si (111) substrate |
| Example 2 | 15Y—X LiNbO₃ | Glass substrate |
| Example 3 | 64Y—X LiNbO₃ | Si (100) substrate |
| Example 4 | 46.3Y—X LiTaO₃ | sapphire substrate |
| Example 5 | 4Y—X LiNbO₃ | Al₂MgO₄ spinel substrate |

The present application claims priorities from the Japanese Patent Application No. 2009-193521 filed on Aug. 24, 2009, the entire contents of which is incorporated herein by reference.

What is claimed is:

1. A method for manufacturing a composite substrate comprising:
a formation step of forming a structural element portion on a front surface of a first substrate;
a grinding step of fixing the first substrate and grinding a back surface of the first substrate; and
a bonding step of bonding a second substrate to the ground back surface with an adhesion layer composed of an adhesive.

2. The method for manufacturing a composite substrate according to claim 1, wherein, in the formation step, a piezoelectric substrate is used as the first substrate; and in the bonding step, a supporting substrate which supports the piezoelectric substrate is used as the second substrate.

3. The method for manufacturing a composite substrate according to claim 2, wherein, in the formation step, an electrode for an elastic wave device is formed, as the structural element portion, on the front surface of the first substrate.

4. The method for manufacturing a composite substrate according to claim 2, wherein the supporting substrate has a smaller coefficient of thermal expansion than the piezoelectric substrate.
